(19) United States
(12) Patent Application Publication
(10) Pub. No.: US 2005/0071182 A1
(43) Pub. Date: Mar. 31, 2005

(54) Multi-tier composite service level agreements

(75) Inventors: Glenn C. Aikens, Raleigh, NC (US); Shawn A. Clymer, Raleigh, NC (US); Bradford Austin Fisher, Chapel Hill, NC (US)

Correspondence Address: Steven M. Greenberg, Esquire;Akerman, Senterfitt P.A., Post Office Box 3188, West Palm Beach, FL, 33401-3188, US

(73) Assignee: International Business Machines Corporation, Armonk, NY (US)

(21) Appl. No.: 10/677,876

(22) Filed: Sep. 30, 2003

(51) Int. Cl. G06F 17/60

(52) U.S. Cl. 705/1

(57) ABSTRACT

A composite, multi-tier SLA. A composite, multi-tier SLA can include two or more service offerings having both internal use only service level objectives and external service level objectives. The composite, multi-tier SLA further can include two or more SLAs combined into a single, composite SLA. Each of the SLAs can correspond to a specific one of the service offerings. Moreover, the SLAs in the composite SLA can have a hierarchical organization based upon dependencies between the service offerings. Notably, each of the SLAs can correspond to one of an outsourced service offering, an internal service offering and an external service offering. Additionally, at least one of the SLAs can expose an external service level objective of a corresponding internal service offering which has been redefined as an internal use only service level objective in an SLA at a higher tier in the hierarchical organization.

### BACKGROUND OF THE INVENTION

1. Statement of the Technical Field

The present invention relates to the field of differentiated service and more particularly to service level agreement (SLA) creation and use.

2. Description of the Related Art

The modern global network can be viewed as a complex interweaving of multiple network technologies, server platforms, client capabilities and application requirements. The vast majority of network technologies handle device requests indiscriminately. That is, regardless of the identity of the requester or the type of request, each device request can be processed with equal priority. Given the exponential increase in network traffic across the Internet, however, more recent network-oriented computing devices have begun to provide varying levels of computing services based upon what has been referred to as a “policy based service differentiation model”.

In a policy based service differentiation model, the computing devices can offer many levels of service where different requests for different content or services which originate from different requesters receive different levels of treatment depending upon administratively defined policies. In this regard, a service level agreement (SLA) can specify an expected level of responsiveness or resource availability based upon a pre-defined policy. More particularly, the SLA is a contract that specifies an agreement between a service provider and customer regarding a level of service to be provided by the service provider to the customer in respect to a specific resource or resources.

The policy based service differentiation model is the logical result of several factors. Firstly, the number and variety of computing applications which generate requests across networks both private and public has increased dramatically in the last decade. Each of these applications, however, has different service requirements. Secondly, technologies and protocols that enable the provision of different services having different levels of security and quality of service (QoS) have become widely available. Yet, access to these different specific services must be regulated because these specific services can consume important computing resources such as network bandwidth, memory and processing cycles. Finally, business objectives or organizational goals can be best served when discriminating between different requests rather than treating all requests for computer processing in a like manner.

Within the modern enterprise, a substantial benefit can be provided for effectively managing differentiated service for different customers and different data so that some customers and data receive a higher level of service than other customers and data on the network. That is to say, where the enterprise satisfies the expected service level of a valued customer, the enterprise can retain the customer. Conversely, where the enterprise fails to satisfy the expected level of service of a valued customer, the enterprise likely can lose the customer. Hence, differentiated service can be an important component of e-commerce inasmuch as a customer always can be viewed as merely “one click away” from a competitor's system where response times falter.

The mechanics of an SLA typically can involve an association with a service offering. The service offering generally can be defined as a collection of service components having pre-determined service level objectives, which together represent a complete service to be provided. A service level objective (SLO), in turn, can be defined as the measurement of a defined breach value or threshold beyond which the objective will have been determined not to have been satisfied and to have been violated. Typically, an SLO can be defined internally, for the view only of the service provider, and externally for the view of both the service provider and the customer. Importantly, an SLA can be viewed as an instance of a service offering as it is actually provided to a customer.

Recently, service providers have begun to offer services that often can be quite complex and formed from the coordinated operation of multiple service components. In this regard, individual SLAs can address selected ones of the components, however, from the customer perspective, it can be important to consider the entire service offering in the context of an SLA for the offering as a whole. Still, the underlying components of the service offering often are managed differently by different systems by applying differing methodologies. Notwithstanding, it would be desirable if an SLA could be constructed which addressed the service offering as a whole from the perspective of the customer, while allowing the service provider to manage the respective components of the service offering, including those components hidden from the view of the customer.

### SUMMARY OF THE INVENTION

The present invention addresses the deficiencies of the art in respect to the formation of SLAs in the enterprise and provides a novel and non-obvious method, system and apparatus for creating and enforcing an SLA for a composition of underlying service offerings in the enterprise. In a preferred aspect of the present invention, a composite, multi-tier SLA can include two or more service offerings having both internal use only service level objectives and external service level objectives. The composite, multi-tier SLA further can include two or more SLAs combined into a single, composite SLA. Each of the SLAs can correspond to a specific one of the service offerings. Moreover, the SLAs in the composite SLA can have a hierarchical organization based upon dependencies between the service offerings. Notably, each of the SLAs can correspond to one of an outsourced service offering, an internal service offering and an external service offering. Additionally, at least one of the SLAs can expose an external service level objective of a corresponding internal service offering which has been redefined as an internal use only service level objective in an SLA at a higher tier in the hierarchical organization.

A method of constructing a composite, multi-tier SLA can include creating an internal SLA for an internal service offering; and, further creating an external SLA for an external service offering which depends upon the internal service offering. The internal SLA can be combined with the external SLA to form a composite SLA. Additionally, the internal and external SLAs can be arranged in a hierarchy within the composite SLA based upon dependencies between the internal and external service offerings to form a composite, multi-tier SLA. Importantly, an outsourced SLA yet further can be created for an outsourced service offering upon which at least one of the external and internal service offerings depend. As such, the outsourced SLA can be further combined in the composite SLA and the outsourced SLA can be further arranged in the hierarchy along with the internal and external SLAs.

In any case, once formulated, the composite, multi-tier SLA can be exposed to a customer over a data communication network. Notwithstanding, in a preferred aspect of the invention, an external service level objective in an SLA which has been combined and arranged in the composite SLA can be redefined to an internal use only service level objective. In this way, the service level objective need not be exposed to the customer, nor need the service level objective be exposed to SLAs at higher tiers in the hierarchy.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is schematic illustration of a process for constructing an exemplary three-tier composite SLA in accordance with the present invention;

FIG. 2 is a pictorial illustration of an exemplary multi-tiered, composite SLA formed through the process of FIG. 1; and,

FIG. 3 is a schematic illustration of an exemplary arrangement of a system configured with the multi-tier, composite SLA of FIG. 2.

### DETAILED DESCRIPTION OF THE PREFERRED EMBODIMENTS

The present invention is a multi-tier, composite SLA. In accordance with the present invention, the components of a service offering can be separated into separate SLAs which can be combined with one another to form a composite SLA representing the complete service offering. The separate SLAs can be enforced with respect to the management of the components by the appropriate managing entities. The composite SLA, by comparison, can represent merely an aggregation of the separate SLAs. Significantly, the separate SLAs can be tiered within the composition so as to ensure that only selected portions of the separate SLAs are exposed at the correct level while others remain hidden from view.

In more particularly illustration, each SLA can be constructed based upon a discrete service offering. For instance, an external SLA can be constructed based upon an external service offering, an internal SLA can be constructed based upon an internal service offering, and an outsourced SLA can be constructed based upon an outsourced service offering. Importantly, existing SLAs can be included in the composite SLA in association with a discrete service offering inasmuch as external service offerings can include any number of external, internal and outsourced SLAs. Internal service offerings, by comparison, can include any number of internal and outsourced SLAs. Finally, outsourced service offerings cannot include any SLAs.

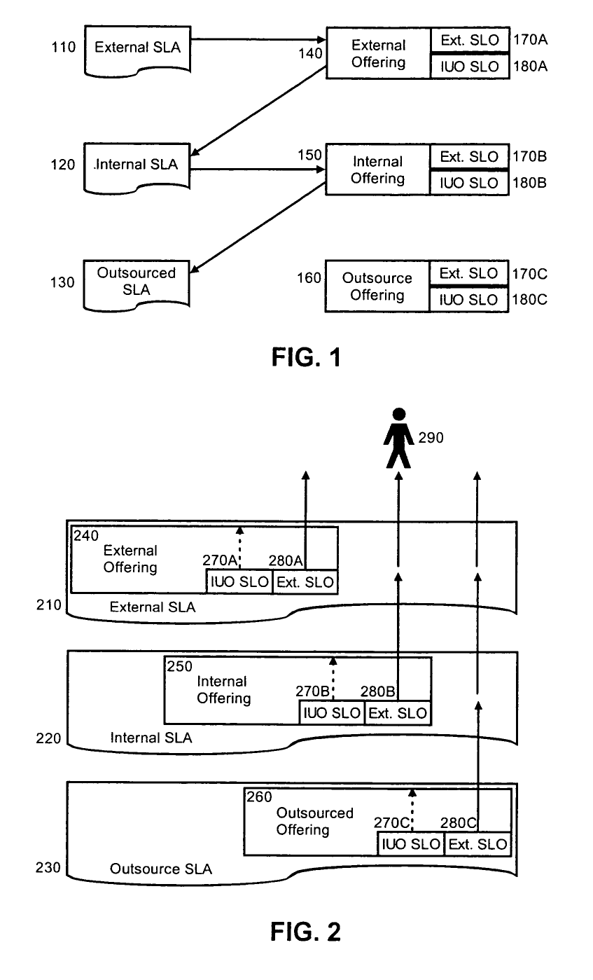

FIG. 1 is schematic illustration of a process for constructing an exemplary three-tier composite SLA in accordance with the present invention. As shown in FIG. 1, initially an outsourced SLA 130 can be created for an outsourced offering 160. Second, an internal offering 150 can be formulated to include the outsourced SLA 130. Third, an internal SLA 120 can be created for the internal offering 150 and included in the formation of an external offering 140. Finally, an external SLA 110 can be created for the external offering 140. Importantly, each of the external offering 140, internal offering 150 and the outsourced offering 160 can include both respective external service level objectives 170A, 170B, 170C, and also respective internal use only service level objectives 180A, 180B, 180C.

Notably, since external offerings and internal offerings can include multiple SLAs, including SLAs of the same tier type, more complex tiering structures are permitted within the context of the present invention. Thus, it will be expected by the skilled artisan that a multi-tiered SLA which has been configured in accordance with the present invention can result in a hierarchical tree structure. Nevertheless, in a preferred albeit non-exclusive aspect of the present invention, preferably dependency loops are not permitted within the multi-tiered SLA architecture, though multiply dependent SLAs are permitted.

FIG. 2 is a pictorial illustration of an exemplary multi-tiered, composite SLA formed through the process of FIG. 1. As shown in FIG. 2, each of the internal use only service level objectives 270A, 270B, 270C of their respective offerings 240, 250, 250 having associated SLAs 210, 220, 230 are not exposed above their respective tiers. Hence, each one of the internal use only service level objectives 270A, 270B, 270C can be evaluated only within the tier in which the internal use only service level objectives 270A, 270B, 270C reside. Most importantly, none of the internal use only service level objectives 270A, 270B, 270C can be viewed by the customer 290.

By comparison, each one of the external service level objectives 280A, 280B, 280C can be exposed to the customer 290 and to each tier therebetween. Yet, in a preferred aspect of the present invention, external service level objectives 280A, 280B, 280C can be redefined as internal use only service level objectives at any higher level tier so as to shield such redefined service level objective from view of the customer or from a higher tier. As an example, the external service level objective 280C within the outsourced offering 260 can be exposed to the service provider, but should not be exposed to the customer 290. Accordingly, the external service level objective 280C of the outsourced offering 260 can be redefined as an internal use only service level objective within the internal SLA 220.

It will be recognized by the skilled artisan that a multi-tier, composite SLA which has been configured in accordance with the inventive arrangements in operation can impart a enhanced consequence upon related processes. More specifically, where an SLA violation occurs within a deeply positioned source tier of the SLA hierarchy, the violation can produce violations at every tier between the deep tier and the root tier closest to the customer. Additionally, the cost or penalty for the violation at the root tier can include the cost or penalty for each violation between the root tier and the deep tier. Accordingly, where feasible, service level objectives remain internal use only.

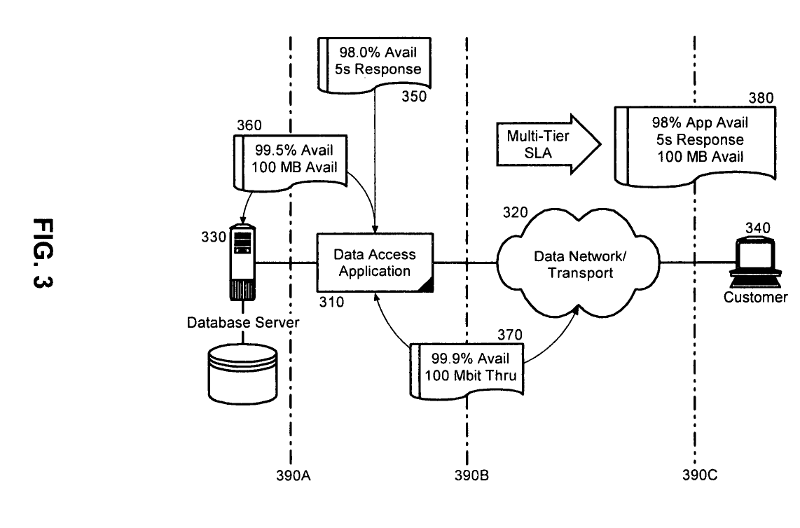

For the purpose of clarity, the following example can be instructive in the configuration and operation of a system incorporating a composite, multi-tier SLA. To that end, FIG. 3 is a schematic illustration of an exemplary arrangement of a system configured with the multi-tier, composite SLA of FIG. 2. The system can include a data access application 310 coupled to a database server 330. A customer 340 can interact with the data access application 310 over the data communications network 320. In this regard, a complete data access service offering can be provided to the customer 340 through an applications interface 390C though the customer 340 can remain unaware of the individual components of the service offering.

As each of the database server 330, data access application 310 and data communications network 320 are discrete service offering components of the external service offering provided to the customer, intracomponent boundaries 390A, 390B can be defined therebetween. Consequently, both the data communications network 320 and the database server 330 can be viewed as service offerings provided to the data access application across the respective boundaries 390B and 390A. In this case of the database server 330, the database server 330 can be viewed as an internal service offering in respect to the data access application 310. In contrast, the data communications network 320 can be viewed as an outsourced service offering in respect to the data access application 310.

Importantly, individual SLAs 350, 360, 370 can be combined in a multi-tier structure to form the composite, multi-tier SLA 380 exposed to the customer. In this regard, the outsourced SLA 370 can specify that the data communications network 320 will provide 99.9% availability and 100 Mbit/s throughput. Similarly, the internal use only SLA 360 can promise 99.5% availability of the database server 330 with at least 100 MB of disk storage. Finally, the internal use only SLA 370 for the data access application 310 can specify 98.0% availability and a 5 second response time.

When combined, the 98.0% availability promise and the 5 second response time of the SLA 350 can be exposed to the customer 340 in the composite, multi-tier SLA 380 as can the 100 MB availability promise of the SLA 360. Notably, the internal use only promise of 99.5% availability of the database server of the SLA 360 can remain hidden from view of the customer 340 as can the 99.9% availability and 100 Mbit throughput promises of the outsourced SLA 370. Importantly, where any of the internal use only promises are breached, the breach need not propagate from the source of the breach up to the exposed tier of the composite, multi-tier SLA 380. Rather, the breach can be contained to the tier in which the promise had been marked internal use only. Consequently, the unnecessary enhancement of the cost of a breach can be avoided by the unwanted propagation of a breach through several tiers of the composite, multi-tier SLA 380.

It will be recognized by the skilled artisan that by generating composite, multi-tier SLAs, complex service offerings can be managed in various and flexible ways according the methodologies of the respective service providers. Different service level objectives within different SLAs can be redefined at different tiers to expose or hide the service level objectives from other service offerings at higher levels and from the customers. Yet, the unified concept of an overall service supported by a respective single SLA can be maintained while permitting the service providers and service customers to access the SLA information differently.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A composite, multi-tier service level agreement (SLA), comprising:
a plurality of service offerings having both internal use only service level objectives and external service level objectives; and,
a plurality of SLAs combined into a single, composite SLA, each of said plurality of SLAs corresponding to a specific one of said service offerings, said plurality of SLAs in said composite SLA having hierarchical organization based upon dependencies between said service offerings.

2. The composite, multi-tier SLA of claim 1, wherein each of said plurality of SLAs corresponds to one of an outsourced service offering, an internal service offering and an external service offering.

3. The composite, multi-tier SLA of claim 1, wherein at least one of said plurality of SLAs exposes an external service level objective of a corresponding internal service offering which has been redefined as an internal use only service level objective in an SLA at a higher tier in said hierarchical organization.

4. A method of constructing a composite, multi-tier service level agreement (SLA), the method comprising the steps of:
creating an internal SLA for an internal service offering;
further creating an external SLA for an external service offering which depends upon said internal service offering;
combining said internal SLA with said external SLA to form a composite SLA; and,
arranging said internal and external SLAs in a hierarchy within said composite SLA based upon dependencies between said internal and external service offerings to form a composite, multi-tier SLA.

5. The method of claim 4, further comprising the steps of:
yet further creating an outsourced SLA for an outsourced service offering upon which at least one of said external and internal service offerings depend;
further combining said outsourced SLA in said composite SLA; and,
further arranging said outsourced SLA along with said internal and external SLAs in said hierarchy.

6. The method of claim 4, further comprising the steps of redefining an external service level objective in an SLA which has been combined and arranged in said composite SLA to an internal use only service level objective.

7. The method of claim 5, further comprising the steps of redefining an external service level objective in an SLA which has been combined and arranged in said composite SLA to an internal use only service level objective.

8. The method of claim 4, further comprising the step of exposing said composite, multi-tier SLA to a customer over a data communication network.

9. The method of claim 4, wherein the arranging step further comprises the step of prohibiting dependency loops within said hierarchy.

10. A machine readable storage having stored thereon a computer program for constructing a composite, multi-tier service level agreement (SLA), the computer program comprising a routine set of instructions for causing the machine to perform the steps of:
creating an internal SLA for an internal service offering;
further creating an external SLA for an external service offering which depends upon said internal service offering;
combining said internal SLA with said external SLA to form a composite SLA; and,
arranging said internal and external SLAs in a hierarchy within said composite SLA based upon dependencies between said internal and external service offerings to form a composite, multi-tier SLA.

11. The machine readable storage of claim 10, further comprising the steps of:
yet further creating an outsourced SLA for an outsourced service offering upon which at least one of said external and internal service offerings depend;
further combining said outsourced SLA in said composite SLA; and,
further arranging said outsourced SLA along with said internal and external SLAs in said hierarchy.

12. The machine readable storage of claim 10, further comprising the steps of redefining an external service level objective in an SLA which has been combined and arranged in said composite SLA to an internal use only service level objective.

13. The machine readable storage of claim 11, further comprising the steps of redefining an external service level objective in an SLA which has been combined and arranged in said composite SLA to an internal use only service level objective.

14. The machine readable storage of claim 10, further comprising the step of exposing said composite, multi-tier SLA to a customer over a data communication network.

15. The machine readable storage of claim 10, wherein the arranging step further comprises the step of prohibiting dependency loops within said hierarchy.
